(19) United States
(12) Patent Application Publication
(10) Pub. No.: US 2002/0034386 A1
(43) Pub. Date: Mar. 21, 2002

(54) Camera for both silver salt photographing and electronic imaging

(75) Inventors: Atsushi Maruyama, Sagamihara-shi (JP); Takeshi Kindaichi, Hachioji-shi (JP)

Correspondence Address: FRISHAUF, HOLTZ, GOODMAN &, LANGER & CHICK, PC, 767 THIRD AVENUE, 25TH FLOOR, NEW YORK, NY, 10017-2023, US

(73) Assignee: Olympus Optical Co., Ltd., Tokyo (JP)

(21) Appl. No.: 09/928,789

(22) Filed: Aug. 13, 2001

(30) Foreign Application Priority Data
Sep. 18, 2000 (JP) 2000-282701

(51) Int. Cl. G03B 17/48

(52) U.S. Cl. 396/429

(57) ABSTRACT

A camera according to the present invention determines a rewind-display time lapse per frame based on the total number of photographed frames and the number of electronic images picked up in the hybrid mode if a frame photographed in the hybrid mode and another photographed in the silver salt mode are present on one film in a mixed manner. If photographing is performed in a mixed state of the hybrid and digital modes with the camera as loaded with a film, the camera rewind-displays images excluding the electronic images picked up in the digital mode. If the film loaded in the camera is photographed in the silver salt mode completely, the rewind-display operation is inhibited. Thus, the camera is so configured as to rewind-display only such electronic images that correspond to a photography frame of the film, thus enabling the user to recognize the contents photographed on the film without misunderstanding.

### CROSS-REFERENCE TO RELATED APPLICATIONS

This application is based upon and claims the benefit of priority from the prior Japanese Patent Application No. 2000-282701, filed Sep. 18, 2000, the entire contents of which are incorporated herein by reference.

### BACKGROUND OF THE INVENTION

1. Field of the Invention

The present invention relates to a camera for both silver salt photographing and electronic imaging which has functions of both an electronic imaging device and a silver salt photographing device. This electronic imaging device has an electronic imaging device for converting a subject image to an electric signal. The above-mentioned silver salt photographing device, on the other hand, has a function of transferring a subject image onto a silver salt film.

2. Description of the Related Art

Conventionally, there have been a variety of proposals on a silver salt photographing-and-electronic imaging camera in which an imaging device such as a CCD is added to a camera using a silver salt film.

For example, a silver salt photographing-and-electronic imaging camera is proposed in Jpn. Pat. Appln. KOKAI Publication Nos. 1-114169 and 10-108054.

This camera combines both an electronic imaging device for converting a subject image into an electric signal and a silver salt imaging device for transferring the subject image onto a silver salt film. By the present technology, a subject is imaged electronically by the electronic imaging device in synchronization with silver salt photographing by the silver salt photographing device. Thus obtained electronic image is displayed on a monitor screen.

Further, such a technology is disclosed in Jpn. Pat. Appln. KOKAI Publication No. 11-327035 that relates to a camera for picking up on a monitor screen of its own body almost the same image as an image exposed onto a film to store it in a memory as image data in order to read out the image data pieces from this memory sequentially and display them when the film is rewound later.

However, in an attempt to apply the above-mentioned prior art to the above-mentioned silver salt photographing-and-electronic imaging camera such as a camera of a first application having the hybrid photography mode and the silver salt photography mode and a camera of a second application having the hybrid photography mode and the digital photography mode, the following problems occur.

That is, the first application type of camera suffers from such a problem that there is no electronic image provided on a frame on which something has been photographed in the silver salt photography mode.

The second application type of camera, on the other hand, suffers from such a problem that an electronic image is not exposed onto a film yet at a point in time when it is obtained in the digital photography mode.

### BRIEF SUMMARY OF THE INVENTION

In view of the above, it is an object of the present invention to provide a silver salt photographing-and-electronic imaging camera which can display proper rewinding both in the silver salt photography and electronic imaging modes so that the user may not misunderstand the situation.

To achieve the above-mentioned object, the camera according to the present invention comprises an electronic photographing portion for recording a subject image by photo-electronic conversion, a silver salt imaging portion for recording the subject image on a silver salt film, a monitor portion for displaying an electronic image picked up by the above-mentioned electronic photographing portion, a mode switching portion for switching between a hybrid mode in which the above-mentioned electronic photographing portion picks up an image in synchronization with the above-mentioned silver salt photographing portion performing a silver salt photography operation and a silver salt mode in which only the above-mentioned silver salt photographing portion performs a silver salt photography operation, a memory portion for storing an electronic image picked up in the above-mentioned hybrid mode, and a display portion for reading out images stored in the memory portion when the above-mentioned silver salt film is being rewound to thereby display them sequentially at the above-mentioned monitor portion, in which this display portion sets a display duration time for each frame according to the number of the frames of each of the electronic images stored.

Furthermore, the camera according to the present invention comprises an electronic imaging portion for recording a subject image by photo-electronic conversion, a silver salt photographing portion for recording the subject image on a silver salt film, a monitor portion for displaying an electronic image picked up by the above-mentioned electronic imaging portion, a mode switching portion for switching between a hybrid mode in which the above-mentioned electronic imaging portion picks up an image in synchronization with the above-mentioned silver salt photographing portion performing an silver salt photography operation and a silver salt mode in which only the above-mentioned silver salt photographing portion performs a silver salt photography operation, a memory portion for storing an electronic image picked up in the above-mentioned hybrid mode, and a display portion for reading out image stored in the above-mentioned memory portion and corresponded to a photography frame of a rewinding operation when the above-mentioned silver salt film is being rewound to thereby display them sequentially at the above-mentioned monitor portion, and when the operation is started, the display portion displays a specific image if the image corresponded to the photography frame doesn't exist.

Furthermore, the camera according to the present invention comprises an electronic imaging portion for recording a subject image by photo-electronic conversion, a silver salt photographing portion for recording the subject image on a silver salt film, a monitor portion for displaying an electronic image picked up by the above-mentioned electronic imaging portion, a mode switching portion for switching between a hybrid mode in which the above-mentioned electronic imaging portion picks up an image in synchronization with the above-mentioned silver salt photographing portion performing an silver salt photography operation and a silver salt mode in which only the above-mentioned silver salt photographing portion performs a silver salt photography operation, a memory portion for storing an electronic image picked up in the above-mentioned hybrid mode and storing a specific image in the above-mentioned silver salt mode, and a display portion for reading out images stored in the above-mentioned memory portion when the above-mentioned silver salt film is being rewound to thereby display them sequentially at the above-mentioned monitor portion.

Furthermore, the camera according to the present invention comprises an electronic imaging portion for recording a subject image by photo-electronic conversion, a silver salt photographing portion for recording the subject image on a silver salt film, a monitor portion for displaying an electronic image picked up by the above-mentioned electronic imaging portion, a mode selecting portion for selecting either a hybrid mode in which the above-mentioned electronic imaging portion picks up an image in synchronization with the above-mentioned silver salt photographing portion performing an silver salt photography operation, a silver salt mode in which only the above-mentioned silver salt photographing portion performs a silver salt photography operation, or a digital mode in which only the above-mentioned electronic imaging portion performs an imaging operation, a memory portion for storing the above-mentioned electronic image, and a display portion for sequentially reading out electronic images photographed in the above-mentioned hybrid mode of those images stored in the above-mentioned memory portion when the above-mentioned silver salt film is being rewound to thereby display those read out images at the above-mentioned monitor portion.

Furthermore, the camera according to the present invention comprises an electronic imaging portion for recording a subject image by photo-electronic conversion, a silver salt photographing portion for recording the subject image on a silver salt film, a monitor portion for displaying an electronic image picked up by the above-mentioned electronic imaging portion, a mode switching portion for switching between a hybrid mode in which the above-mentioned electronic imaging portion picks up an image in synchronization with the above-mentioned silver salt photographing portion performing an silver salt photography operation and a digital mode in which only the above-mentioned electronic imaging portion performs an imaging operation, a memory portion for storing the above-mentioned electronic image, and a display portion for reading out images stored in the above-mentioned memory portion when the above-mentioned silver salt film is being rewound to thereby display them sequentially at the above-mentioned monitor portion, in which this display portion displays images except the electronic images picked up in the above-mentioned digital mode.

Furthermore, the camera according to the present invention comprises an electronic imaging portion including an imaging element and an imaging optical system for forming a subject image on this imaging element, a nonvolatile memory element for storing electronic image data output from the above-mentioned electronic imaging portion, a display which can display the above-mentioned electronic image data, a signal processor circuit for controlling an imaging operation by the above-mentioned electronic imaging portion, a storing operation by and a read-out operation from the above-mentioned nonvolatile memory element, and a display operation by the above-mentioned display, a silver salt film photography portion including a silver salt photography optical system for forming the above-mentioned subject image on a silver salt film and an adjusting mechanism for adjusting an exposure on the above-mentioned silver salt film, a rewinding mechanism for rewinding the above-mentioned silver salt film into a cartridge, a switch operable to set either a hybrid photography mode for almost simultaneously performing an exposure operation by the above-mentioned silver salt film photography portion and an imaging operation by the above-mentioned electronic imaging portion or a non-hybrid photography mode for performing either one of an exposure operation by the above-mentioned silver salt film photography portion and an imaging operation by the above-mentioned electronic imaging portion, a release switch, a CPU for controlling, when the above-mentioned release switch is operated, an operation by the above-mentioned signal processor circuit and an exposure operation by the above-mentioned silver salt film photography portion according to the above-mentioned photography mode, in which the above-mentioned signal processor circuit reads out electronic images picked up in the above-mentioned hybrid mode from the above-mentioned memory means when the above-mentioned rewinding mechanism is performing a winding operation to thereby display them sequentially at the above-mentioned display.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently embodiments of the invention, and together with the general description given above and the detailed description of the embodiments given below, serve to explain the principles of the invention.

FIG. 1 is perspective view for showing an upper front part of a silver salt photographing-and-electronic imaging camera related to a first embodiment of the present invention;

FIG. 2 is a perspective view for showing a rear part of the silver salt photographing-and-electronic imaging camera according to the first embodiment;

FIG. 3 is a block diagram for showing in further detail a configuration of the silver salt photographing-and-electronic imaging camera related to the first embodiment;

FIG. 4 is a flowchart for showing a main sequence of the silver salt photographing-and-electronic imaging camera related to the first embodiment;

FIG. 5 is a flowchart for showing an operation of a subroutine “photographing sequence” performed at a step S11 of FIG. 4;

FIG. 6 is a memory map of a flash memory 50;

FIG. 7 is a flowchart for showing an operation of a subroutine “film winding up” called at a step S35 of FIG. 5;

FIG. 8 is a table for showing the contents stored in the flash memory 50 in a second embodiment; and

FIG. 9 is a flowchart for explaining an operation of displaying a rewinding operation corresponding to the second embodiment.

### DETAILED DESCRIPTION OF THE INVENTION

The following will describe embodiments in which the present invention is applied to a silver salt photographing-and-electronic imaging camera with reference to the drawings.

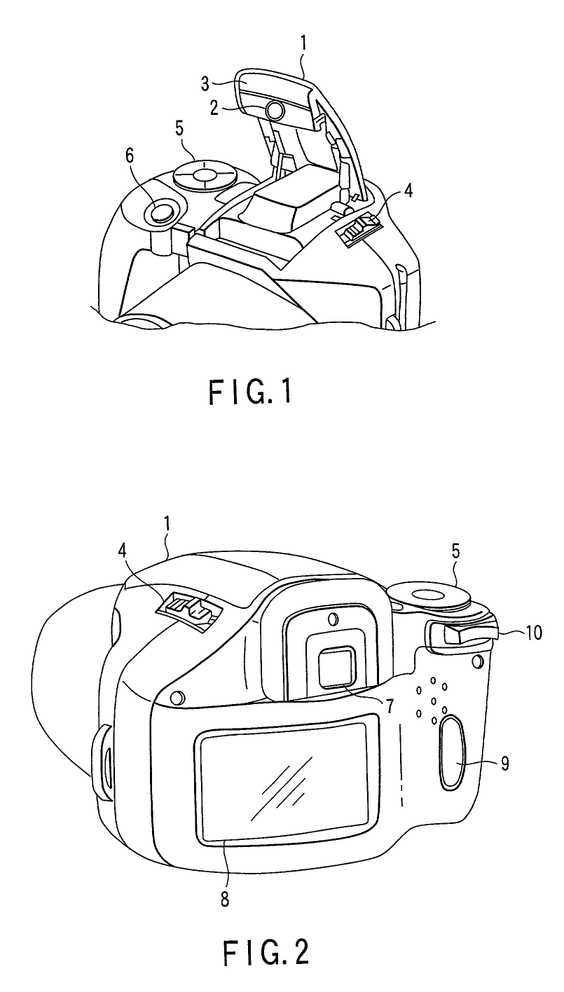

First, the silver salt photographing-and-electronic imaging camera related to the first embodiment of the present invention is described as against a perspective view of an upper front part thereof shown in FIG. 1.

As shown in FIG. 1, at a predetermined position of a pop-up unit 1 is disposed part of an imaging optical system 2 for forming a subject image on an electronic imaging element not shown. Near this imaging optical system 2 is also disposed a panel 3 for passing a strobe light therethrough.

Those imaging optical system 2 and panel 3 are integrated with each other so as to act as interlocked with a pop-up operation of the above-mentioned pop-up unit 1.

At a predetermined position of the camera is also disposed a power switch 4. When this power switch 4 is turned ON, as interlocked with it, the above-mentioned pop-up unit 1 pops up a cartridge mechanically in configuration as shown in the figure.

Besides, the camera is provided with an operating member 5 and a release switch 6. This operating member 5 acts to select the photography mode. The release switch 6 acts to instructs that a silver salt photographing or electronic imaging device should start its operation.

FIG. 2 is a perspective view for showing a rear part of the silver salt photographing-and-electronic imaging camera related to the first embodiment. In this embodiment, the pop-up unit 1 is housed in the camera body.

On the rear surface of the camera is disposed an eyepiece window 7.

This eyepiece window 7 is an optical finder for observing a subject image based on a subject light which has passed through a photography lens not shown.

Below this eyepiece window 7 is disposed an LCD monitor portion 8.

This LCD monitor portion 8 is provided to display an electronic image taken in from the electronic imaging element not shown.

On the right side of this LCD monitor 8 is in turn disposed a confirming window 9.

This confirming window 9 enables confirming the type of a film loaded in the camera.

To the upper right on the rear surface of the camera is disposed a zoom up/down switch 10. This zoom up/down switch 10 is provided to manually change a focal distance of a zoom lens not shown.

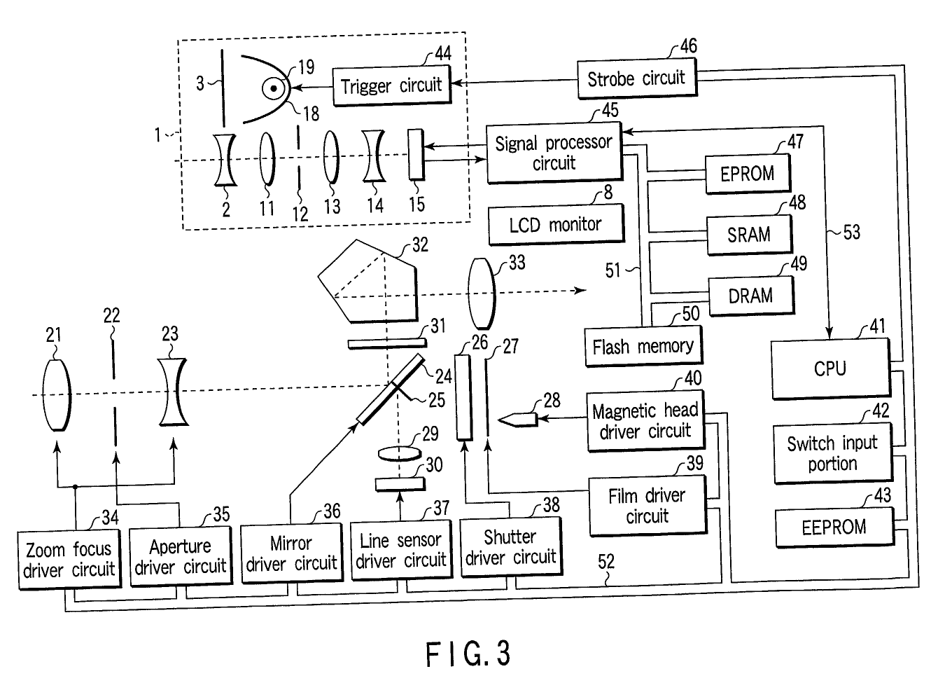

FIG. 3 is a block diagram for explaining in further detail a configuration of the silver salt photographing-and-electronic imaging camera related to the first embodiment of the present invention.

First, components related to the silver salt photographing device is described are described.

As photography lenses for forming an image of a subject are provided a convex lens 21 and a concave lens 23. Between those photography lenses (21, 23) is disposed an aperture mechanism 22. This aperture mechanism 22 is driven and controlled by the aperture driver circuit 35.

On an optical path of the above-mentioned photography lenses (21, 23) and behind the concave lens 23 is provided a movable mirror 24 which is half-mirror shaped at roughly a middle thereof. At the central part of the back surface of this movable mirror 24 is disposed a sub-mirror 25 at such a predetermined angle so as to reflect s subject light downward.

On a reflection optical path of the above-mentioned sub-mirror 25 and perpendicular to the figure is disposed a separator optical system 29 for separation of two images which is comprised of two optical systems.

At a position of subject-image forming by this separator optical system 29 is disposed a line sensor 30. This line sensor 30 is driven and controlled by a line sensor driver circuit 37.

The above-mentioned sub-mirror 25, separator optical system 29, line sensor 30, etc. are combined to make up a focal point detecting system using a publicly known phase difference method.

In such a configuration, a CPU41 obtains a distance between two images based on a signal obtained through the above-mentioned line sensor driver circuit 37 to thereby operate data of a drive amount by which the above-mentioned photography lenses (21, 23) are to be driven to a focusing point.

This drive amount data is sent to a later staged zoom focus driver circuit 34.

Then, the zoom focus driver circuit 34 changes a focal point of the above-mentioned photography lenses (21, 23).

Of course this zoom focus driver circuit 34 includes a drive source such as, not shown, an electromagnetic motor or supersonic motor, a driver circuit for controlling this drive source, an encoder device for detecting a lens position, etc.

On a reflection optical path of the above-mentioned movable mirror 24, on the other hand, are disposed a focal point plate 31, a penta-prism 32, and a finder eyepiece optical system 33.

In this embodiment, the above-mentioned optical finder is provided in addition to a later-described LCD monitor 8 as a subject monitor in view of a fact that camera holding performance is improved and manual fluctuations can be prevented more easily by permitting a camera operator to photograph a subject as viewing an optical finder rather than by permitting him to do so as viewing the LCD monitor portion 8.

The above-mentioned movable mirror 24 is driven by a mirror driver circuit 36. A shutter 26 is driven by a shutter driver circuit 38. When the above-mentioned movable mirror 34 is elevated in a quick return manner to thereby open the above-mentioned shutter 26, a subject image is formed on a silver salt film 27 and then exposed.

The CPU41 in this case operates a numerical aperture of the aperture mechanism 22 and a shutter speed required to obtain a proper exposure, based on a subject brightness value output from a later described signal processor circuit 45, a film sensitivity detected by a film sensitivity detector circuit not shown, and a program diagram not shown. The above-mentioned shutter 26 is driven and controlled at a shutter speed thus operated by this CPU41.

The above-mentioned silver salt film 27 has a magnetic recording layer formed thereon. A magnetic head 28 is disposed so as to come in contact with this magnetic recording layer.

This magnetic head 28 is driven by an output of a magnetic head driver circuit 40 to magnetically record various kinds of information on the above-mentioned magnetic recording layer.

Furthermore, the camera body is provided therein with a film driver circuit 39 for winding up the above-mentioned film 27 each time one frame is completed in photographing. During this winding up operation, the above-mentioned magnetic head 28 records magnetically.

Besides the above, the switch input portion 42 comprises the first and second release switches, the power switch 4, the operating member 5, various switches such as a detecting switch not shown for detecting an operation of mechanical mechanism, and members. This first release switch is turned ON as interlocked with half-depression of the release switch 6. This second release switch is turned ON as interlocked with deep-depression of the release switch 6. An EEPROM43 is a nonvolatile memory for storing therein an adjustment value for each camera, because the cameras are each shipped at a factory with their fluctuations as suppressed.

The following will describe components related to the electronic imaging device.

Convex lenses 11 and 13 and concave lenses 2 and 14 are disposed as imaging lenses for forming an image of a subject on a CMOS imager of the IC chip 15. Between those imaging lenses (2, 11, 13, 14) is disposed a fixed aperture mechanism 12. Those are all incorporated in the pop-up unit 1 as described above.

A subject image thus formed on the CMOS imager by those imaging lenses (2, 11, 13, 14) is converted into an analog image signal. This analog image signal is in turn converted into digital image data by a control circuit (which is detailed later) formed on the IC chip 15.

This digital image data is output to the signal processor circuit 45.

This signal processor circuit 45 has therein a RISC processor, a color processor, a JPEG core. This signal processor circuit 45 performs compression/decompression of the digital image signal obtained from the control circuit of the IC chip 15, white balance processing, edge enhancement processing, processing of synthesis with character information, and processing of conversion of a brightness signal, a color difference signal, etc. into a composite signal output to the LCD monitor 8.

An EPROM47 stores therein a program processed by the processor included in the above-mentioned signal processor circuit 45. An SRAM (static RAM) 48 and a DRAM (dynamic RAM) 49 are used to temporarily store images before or under image processing. The flash memory 50, on the other hand, is a nonvolatile memory for storing images determined finally. The contents stored in the flash memory 50 are not lost even when the camera is powered off.

The field angle of the above-mentioned imaging lenses (2, 11, 13, 14) is roughly the same as the shortest focal point of the imaging lenses (21, 23), that is, the imaging field angle of a so-called wide end. If the focal distance of the imaging lenses (21, 23) is changed by a zoom-focus driver circuit 34, the above-mentioned signal processor circuit 45 can expand or reduce (hereinafter electronic zoom) an electronic image to thereby roughly match a field angle of an electronic image displayed at the LCD monitor portion 8 and that of a latent image recorded on the silver salt film 27.

The following will describe a strobe.

The strobe permits a xenon gas contained in a light-emitting tube 19 to be excited by a trigger signal output from a trigger circuit 44 including at least a trigger transformer 20. Thus emitted light is reflected by a reflector 18.

This reflected light is in turn applied through the panel 3 to the subject.

The above-mentioned trigger circuit 44, light-emitting tube 19, reflector 18, and fresnel lens 3 are all incorporated in the pop-up unit 1.

Note here that the light-emitting field angle of the strobe is almost the same as the imaging field angle of the shortest focal point of the imaging lenses (21, 23), that is, the imaging field angle of the so-called wide end.

The above-mentioned strobe control circuit 46 gives an instruction that the main capacitor for the strobe not shown should be charged or that the trigger circuit 44 should emit a light.

The above-mentioned strobe circuit 46, zoom-focus driver circuit 34, aperture driver circuit 35, mirror driver circuit 36, line sensor driver circuit 37, shutter driver circuit 38, film driver circuit 39, magnetic head driver circuit 40, EEPROM43, switch input portion 42, and CPU41 are all interconnected via a data bus 52 in data communication with each other. The operations of those driver circuits are governed and controlled by the CPU41.

Furthermore, the signal processor circuit 45, EPROM47, SRAM48, DRAM49, and flash memory 50 are interconnected via a data bus 51 in communication with each other. The operations of those circuits are governed and controlled by the signal processor circuit 45.

The CPU41 and the signal processor circuit 45 are interconnected via a communication line 53 in communication with each other. These two perform matching of timing for taking in an image signal or timing between electronic imaging and silver salt photographing.

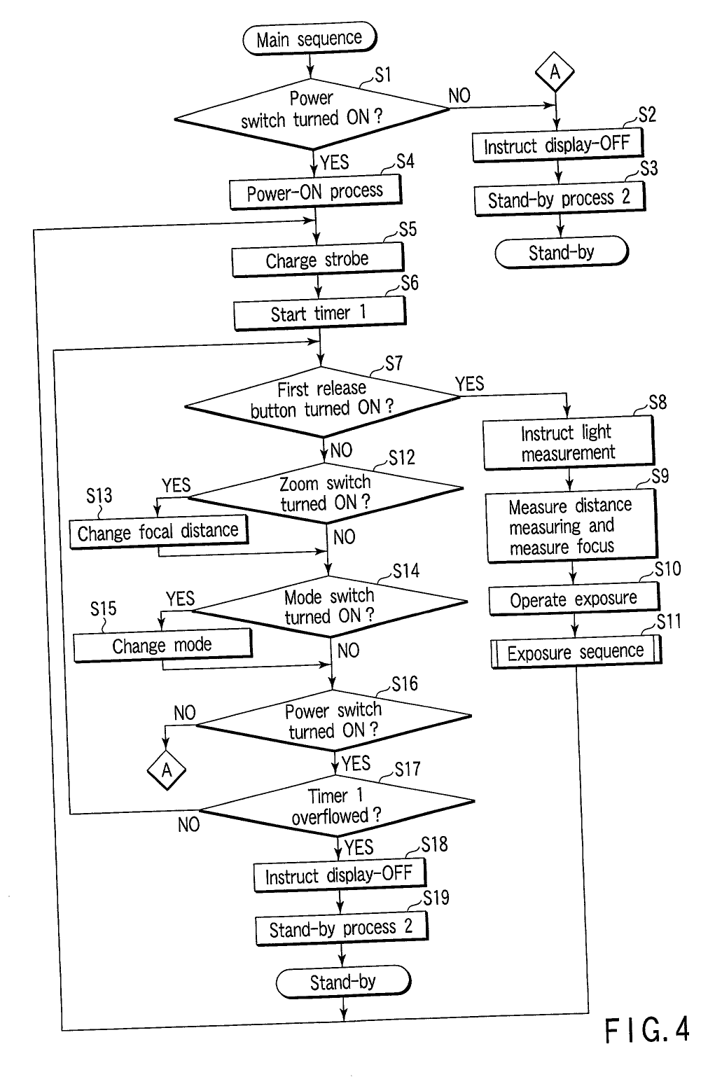

The following will describe a main sequence for the silver salt photographing-and-electronic imaging camera related to the first embodiment with reference to a flowchart of FIG. 4.

When a power supply (battery) is mounted to the camera, the CPU41 is initiated to call the main sequence, thus performing the following processes.

First, it is decided whether the camera power switch is turned ON (step S1).

If, at this step of S1, it is decided that the above-mentioned power switch is OFF, the CPU41 sends to the signal processor circuit 45 an instruction for turning OFF displaying at the LCD monitor portion 8 (step S2).

Next, the CPU41 performs a stand-by process 1 (step S3).

This stand-by process 1 is performed, so called, to set conditions, before the CPU41 is stopped in operation, for permitting the CPU41 to restart its operations after being stopped.

In this stand-by process 1, setting is made such that operations are started upon turn-ON of the power switch 4 to stop the CPU41 in operation. When the stand-by state is released, the process restart from the START of the main sequence.

When it is decided that the power switch 4 is ON at the above-mentioned step of S1, on the other hand, the CPU41 drives the photography lenses 21 and 23 out to a wide position from a body-sunk position not shown (step S4).

Then, the main capacitor, not shown, included in the strobe circuit 46 is charged (step S5). Then, a timer 1 incorporated in the CPU41 starts counting (step S6).

This timer 1 is counted up for each predetermined time lapse, starting counting from a predetermined initial value set at it.

Subsequently, when the release switch 6 is pressed, the CPU41 decides whether the first release switch is turned ON (step S7).

If it is decided that the first release switch is ON at this step of S7, such an instruction is sent through the communication line 53 that an image signal should be taken in from the imager on the IC15 (step S8). Based on this image signal, an average brightness on the photography screen is calculated. Note here that a measurement may be, not an average brightness, a central gravity-point measurement value obtained by weighting an electric signal of each picture element.

Subsequently, the CPU41 obtains a distance between the two images based on the signal input via the line sensor driver circuit 37 to thereby operate a driving amount of the photography lenses required to drive them to their focusing positions (step S9). This driving amount is transferred to the zoom focusing driver circuit 34 in order to change the focusing positions of the above-mentioned photography lenses 21 and 23 respectively.

Then, the CPU41 operates a numerical aperture of the aperture 22 and a shutter speed required by the publicly known technology to obtain a proper exposure, based on a subject brightness value obtained at the above-mentioned step of S8, a program diagram etc. corresponding to the photography mode, and a film sensitivity detected by the film sensitivity detector circuit not shown (step S10).

The CPU41 then calls a subroutine “photography sequence” detailed later, to permit the CMOS imager of the IC chip 15 to expose the film 27 (step S11).

If it is decided that the first release switch 10 is OFF at the above-mentioned step of S7, the CPU41 decides whether the zoom up/down switch 10 of the camera is ON (step S12).

When the zoom up/down switch 10 is decided to be ON at this step of S12, the zoom focus driver circuit 34 changes the focal distances of the photography lenses 21 and 23 to then permit the processing to go to step S14 (step S13).

If the zoom up/down switch 10 is decided not to be ON at step S12, the processing immediately goes to step S14.

Subsequently, the CPU41 decides whether the mode switch built in the switch input portion 42 of the camera is turned ON (step S14).

When the mode switch is decided to be ON at this step, the mode switch 5 is used to switch among the hybrid mode in which silver salt photography and electronic imaging operations are performed almost simultaneously, the silver salt mode in which only a silver salt photography operation is performed, and the digital mode in which only an electronic imaging operation is performed, to then permit the processing to go to step S16 (step S15).

If the mode switch is decided to be OFF, the processing immediately goes to step S16.

Subsequently, it is decided whether the power switch 4 of the camera is turned ON (step S16). If the power switch 4 is decided to be OFF at this step, the processing of the above-mentioned step of S2 and the subsequent are performed.

When the power switch 4 is decided to be ON, on the other hand, the timer 1 starts counting to decide whether a predetermined time lapse has elapsed (step S17).

If the predetermined time lapse has not elapsed at this step of S17, the processing returns to the above-mentioned step of S7 to then repeat the above-mentioned operations. If the predetermined time lapse has elapsed at this step of S17, on the other hand, the timer 1 overflows.

If this timer 1 overflows, the processing of the step of S18 and the subsequent are performed. This serves to enter the CPU41 into a stand-by state for energy saving if the operating switch such as the power switch 4 is not operated upon elapsing of the predetermined time lapse.

That is, if the predetermined time lapse elapses after starting to display a specified image or a most recent image as picked up, the CPU41 sends an instruction to the signal processor circuit 45 to turn OFF displaying at the monitor 8 (step S18).

Then, the processing shifts to a stand-by process 2 (step S19). Like in the case of step S3, this standby process 2 acts to set conditions, before the CPU41 is stopped in operation, for permitting the CPU41 to restart its operations after being stopped.

In the stand-by process 2, setting is made such that operations may be started when the switch is changed in status as interlocked with a variety of operating buttons. Then, the CPU41 is stopped in operation. If the stand-by state is released, the processing is performed from the step of S8.

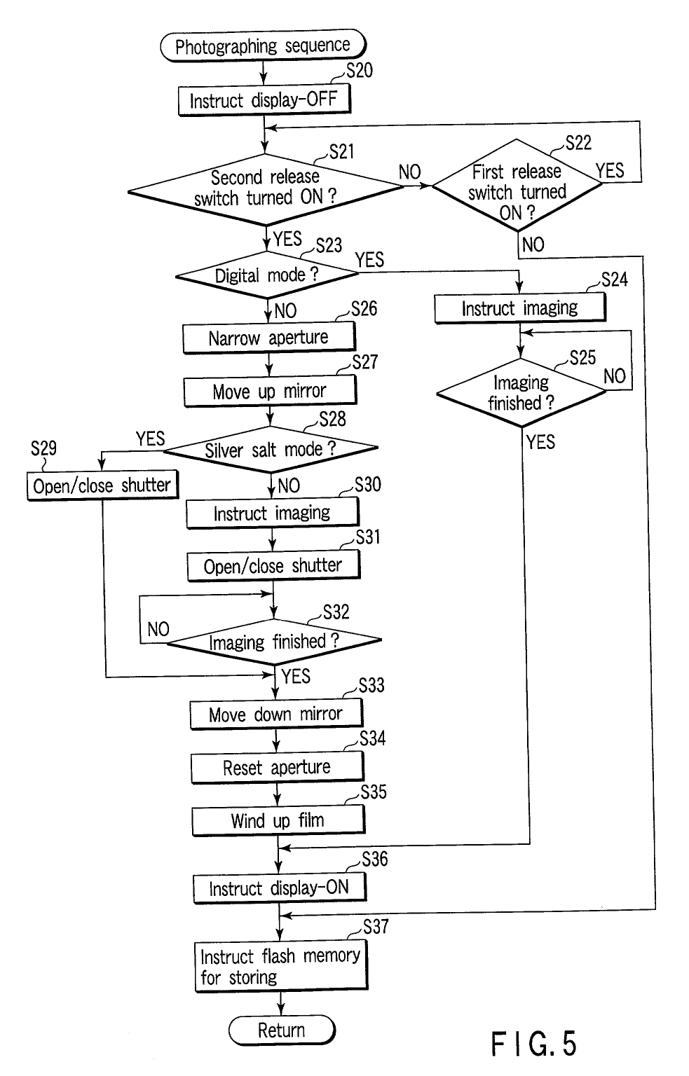

The following will describe a subroutine “photography sequence” performed at step S11 of FIG. 4 with reference to a flowchart of FIG. 5.

When this subroutine is entered, the CPU4 sends an instruction to the signal processor circuit 45 so as to turn OFF displaying at the LCD monitor 8 (step S20).

Subsequently, the CPU41 checks a state of the second release switch which is turned ON as interlocked with deep depression of the release switch 6 (step S21).

If this second release switch is not ON, the CPU41 check a state of the first release switch (step S22). If the first release switch is not ON at this step of S22, the processing jumps to step S37 and, if it is ON, repeats decision at step S21.

When the second release switch is decided to be ON at the above-mentioned step of S21, the CPU41 decides whether the digital mode is set (step S23).

When the digital mode us set, the signal processor circuit 45 is instructed to perform photographing (step S24).

Then, the CPU41 decides whether a series of image processes are finished after completion of the photographing (step S25).

The above-mentioned series of image processes involve converting an image signal obtained from the CMOS imager on the IC chip 15 into digital image data and the subsequent compression, expansion, and reduction of that digital image data as well as character synthesis.

When a completion command for those operations is transferred from the signal processor circuit 45 via the communication line 53, the processing at step S35 and the subsequent are performed.

If the digital mode is not set at the above-mentioned step of S23, the aperture 22 is narrowed to a set numerical aperture (step S23) based on an output of the aperture driver circuit 35. This numerical aperture is determined beforehand by the publicly known technology in the main routine based on a subject brightness, a film sensitivity, a program diagram, etc.

Subsequently, under the control of the CPU41, the movable mirror 24 is saved out of the photography optical path according to an output of the mirror driver circuit 36 (step S27).

Then, the CPU41 decides whether the silver salt mode is set (step S28).

When the silver salt mode is set at this step of S28, the shutter driver circuit 38 places its control output to provide a shutter speed at which the shutter 26 has been driven and then permits the processing to go to step S33 (step S29). This shutter speed is determined beforehand in the main routine as in the case of the numerical aperture.

If the silver salt mode is set at the above-mentioned step of S28, on the other hand, a photography instruction is sent to the signal processor circuit 45 (step S30).

Then, the shutter driver circuit 38 places its control output to provide a shutter speed at which the shutter 26 has been driven (step S31).

Then, the CPU41 decides whether a series of image processes are finished after completion of the photographing (step S32).

When the series of image processes are finished at the above-mentioned step of S27, under the control of the CPU41, the movable mirror 24 once saved at the above-mentioned step of S27 is returned to its regular position on the photography optical path (step S33).

Then, under the control of the CPU41, the aperture mechanism 22 narrowed at step S25 is returned to an open state (step S34).

Subsequently, under the control of the CPU41, the film driver circuit 39 places an output to wind up the film 27 by one frame (step S35). During this step, the magnetic head 28 records predetermined data magnetically on the magnetic recording layer of the film 27, which technology itself is publicly known and omitted in description.

Then, the CPU41 sends an instruction to the signal processor circuit 45 to perform a display operation (step S36). During this step, a photographed image is displayed at the LCD monitor 8.

Thus, the compressed digital image data and a photography mode, a film frame No., and a hybrid frame No. are stored in the flash memory 49.

Afterwards, return is made to the main routine (step S37).

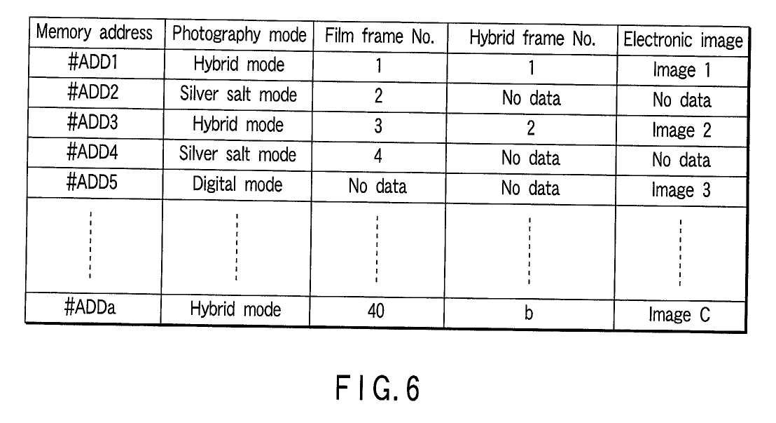

At this point in time, the photographed electronic image is stored in the flash memory 50, which situation is shown in FIG. 6.

As shown in FIG. 6, a storage area corresponding to one memory address stores therein the following data items.

They are a “photography mode (hybrid mode, silver salt mode, digital mode)” employed in photography, a “film frame No.” at the time of photographing in the hybrid or silver salt mode, a “frame No. (hereinafter called hybrid frame No.)” at the time of photographing in the hybrid mode, and a compressed electronic image (digital image data).

For example, a storage area corresponding to memory address #ADD1 stores therein a hybrid mode employed in photographing, a film frame No. of “1”, and a hybrid frame No. of “1”.

A storage area corresponding to memory address #ADD2 stores therein a silver salt mode employed in photographing, a film frame No. of “2”, and a hybrid frame No. and an electronic image of “NO DATA” because of no electronic image being present. A storage area corresponding to memory address #ADD5 stores therein a digital mode employed in photographing, a film frame No. of “NO DATA” because of nothing being photographed on the film, and a hybrid frame No. of “NO DATA” because of no exposure on the film with only an electronic image being present.

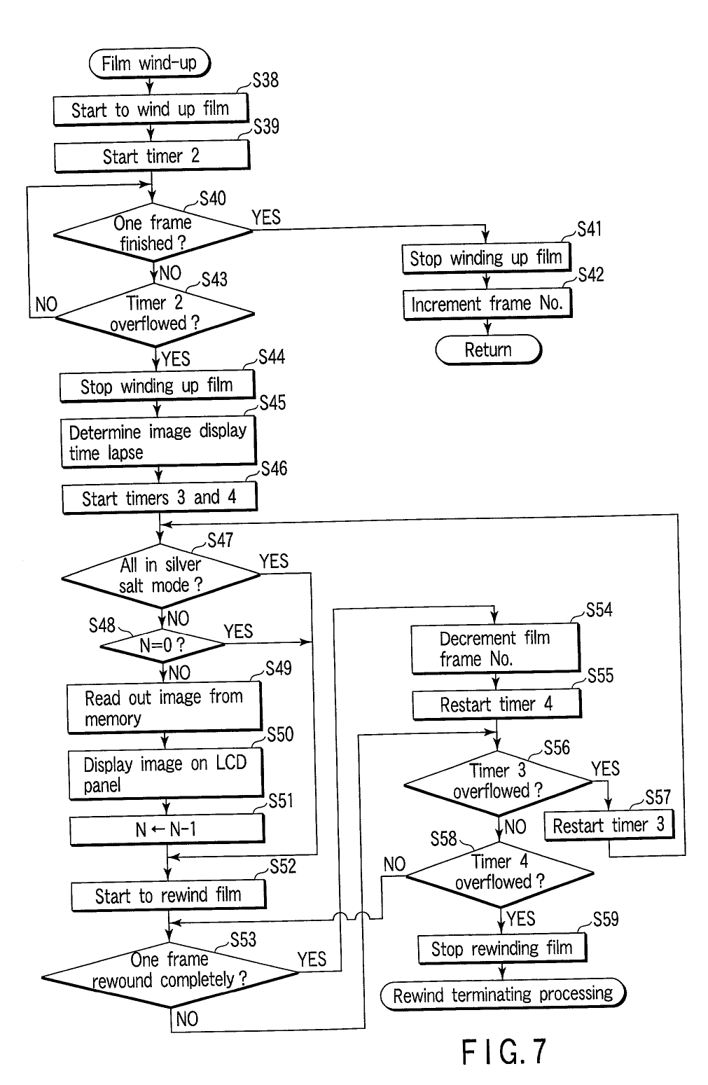

The following will describe in detail the operations of a subroutine “film wind-up” called at step S35 of FIG. 5 with reference to a flowchart of FIG. 7.

When this subroutine is called, first the film frame driver circuit 39 starts winding up the film 27 (step S38).

Subsequently, a timer 2 built in the CPU41 starts counting (step S39). This timer 2 is counted up for each predetermined time lapse, starting counting from an initial value set at it.

Subsequently, the CPU41 decides whether the film 27 is wound up by one frame (step S40). When it is decided that the film is wound up by one frame at this step of S40, the film wind-up operation is stopped (step S41).

If photographing is performed using a film frame No. and the hybrid mode, the hybrid frame No. is incremented (step S42).

Then, return is made to the subroutine “photography sequence”.

If one frame is not completely wound up at the above-mentioned step of S40, it is decided whether the timer 2 is overflowed before the film 27 is wound up by one frame (step S43).

If the timer 2 overflows at this step of S43, it is decided that the film 27 has terminated, thus permitting the processing to shift to the film rewind processing.

That is, first the film wind-up operation is stopped (step S44).

Then, to display a rewind operation, a time lapse during which one image is displayed is determined (step S45). This display time lapse can be obtained by dividing an expected value of time required to rewind the film 27 completely by a maximum value of the hybrid frame No.

Subsequently, timer 3 and 4 built in the CPU41 start counting (step S46). These timers 3 and 4 are counted for each predetermined time lapse. Those counters start counting from an initial value set at them. The timer 3 is used as a counter for indicating a rewind-display time lapse for each frame. The timer 4 is used as a counter for deciding whether a film rewind operation is terminated.

Subsequently, data stored in the flash memory 50 is canned to decide whether all the photography frames have been photographed in the silver salt mode (step S47).

If it is decided that all the frames have been photographed in the silver salt mode at this step of S47, rewind display is not required, so that jump is made to step S52 to perform only a process of rewinding the film. Otherwise, some frames have been photographed in the hybrid mode, so that the step of S48 and the subsequent are performed in order to display rewind.

That is, it is decided whether the hybrid frame No. is “0” (step S48).

If the hybrid frame No, is “0”, it means that images to be rewind-displayed have all been displayed completely, jump is made to step S52.

If the hybrid frame No. is any other than “0”, an image display process of the step of S49 and the subsequent is performed.

That is, an electronic image corresponding to a hybrid frame No, is read out from the flash memory 50 (step S49). Then, thus read out image is displayed on the LCD panel (step S50). Further, the hybrid frame No. N is decremented (step S51). Then, the film driver circuit 39 starts rewinding the film (step S52).

Subsequently, it is decided whether one frame has been rewound (step S53).

If it is decided that one frame has not been rewound at this step of S53, the processing shifts to step S56. If it is decided that one frame has been rewound at this step of S53, the film frame No. is decremented (step S54).

Subsequently, the initial value is re-set to the timer 4 to start counting, thus making shift to step S56 (step S55).

Subsequently, the CPU41 decides whether the timer 3 has overflowed (step S56).

If the timer 3 has overflowed and so it is decided that the rewind-display time lapse has elapsed at this step of S56, the initial value is re-set to the timer 3 to start counting (step S57).

If the timer 3 has not overflowed at step S56, the timer 4 is decided on whether it has overflowed (step S58).

If the timer 4 has overflowed and so it is decided that a rewind operation has been completed at this step of S58, the film rewinding operation is suspended to jump to a rewind-completing process not shown (step S59).

If the timer 4 has not overflowed at this step of S58, return is made to the above-mentioned step of S53 to then repeat the above-mentioned operations.

The rewind display described in this first embodiment is configured so that only electronic images photographed in the hybrid mode are displayed, omitting those photographed in the digital mode.

The following will describe a second embodiment of the present invention with reference to an example where a predetermined default image is displayed as an electronic image corresponding to a frame photographed in the silver salt mode.

A default image may be more discernible if it is accompanied by an explanation such as “no electronic image” or “photographed in silver salt mode”.

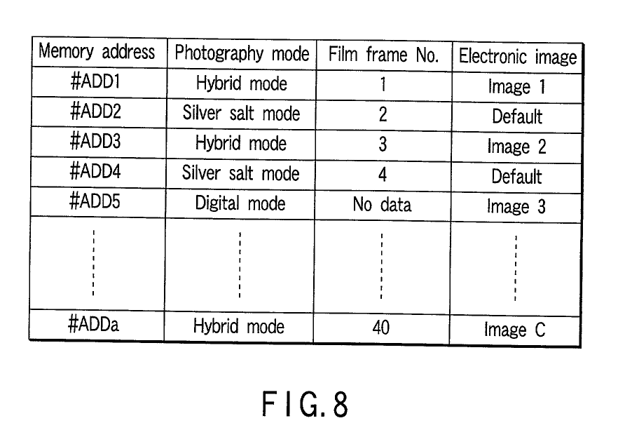

FIG. 8 shows the contents stored in the flash memory 50 in the second embodiment. If an image is photographed in the silver salt mode, a default image is stored as the digital image data. In FIG. 8, for example, it corresponds to memory address #ADD2 or #ADD4.

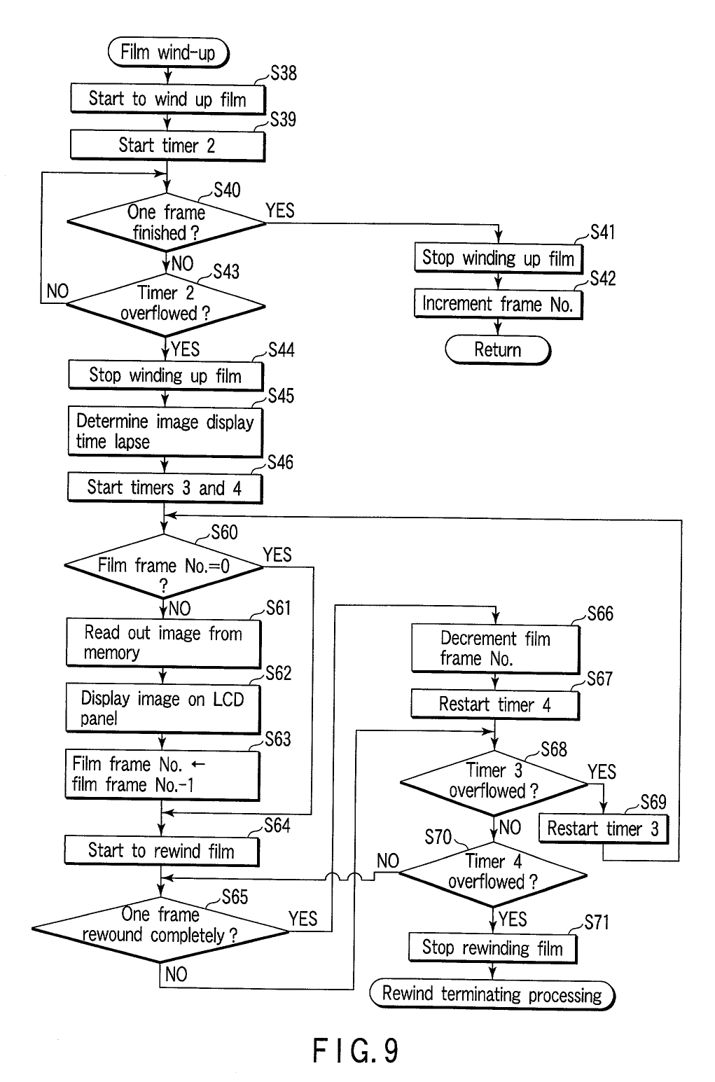

The following will describe a rewind-display operation corresponding to the second embodiment with reference to a flowchart of FIG. 9. Here, the same contents are indicated by the same step No. in the first embodiment (FIG. 7) and so their explanation is omitted.

The processing from step S38 to S46 is the same as that in FIG. 7.

At step S60, the film frame No is decided on whether it is “0”.

If the film frame No. is “0” and it is decided that images to be rewind-displayed have all been displayed completely at this step of S60, the processing jumps to step S64.

If the film frame No. is any other than “0” at step S60, an image display process at step S61 and the subsequent is performed.

At step S61, an electronic image corresponding to the film frame No. is read out from the flash memory 50. At the next step of S62, the image thus read out from the memory is displayed on the LCD panel. At step S63, the film frame No. is decremented.

The processing of the following steps S52 or S59 is the same as that shown in FIG. 7 and so its explanation is omitted here.

As described above, in the first embodiment of the present invention, first, if a frame photographed in the hybrid mode and another photographed in the silver salt mode are present in a mixed manner on the same film, the rewind-display time lapse per frame is determined on the basis of the total number of the photographed frames and the number of the electronic images picked up in the hybrid mode. Second, if a film is photographed as loaded in the camera in a state where the hybrid and digital modes are mixed, rewind display is performed excluding the electronic images picked up in the digital mode. Third, if films loaded in a camera having both the hybrid and silver salt modes are all photographed in the silver salt mode, rewind display is inhibited.

This permits only an electronic image corresponding to a photographed frame of the film to be rewind-displayed, thus enabling the user to recognize the contents photographed on the film without misunderstanding.

Furthermore, in the second embodiment, a default image is displayed which corresponds to a frame photographed in the silver salt mode, thus providing easier understanding.

According to the present invention, it is possible to provide proper rewind display both in the silver salt photography and electronic imaging modes, thus providing the user with a silver salt photographing-and-electronic imaging camera free of misunderstanding.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A camera comprising:
electronic imaging means for recording a subject image by photoelectric conversion;
silver salt photographing means for recording a subject image on a silver salt film;
monitor means for displaying an electronic image picked up by said electronic imaging means;
mode switching means for switching between a hybrid mode in which said electronic imaging means picks up an image in synchronization with a silver salt photographing operation by said silver salt photographing means and a silver salt mode in which only a silver salt photographing operation by said silver salt photographing means is performed;
memory means for storing an electronic image picked up in said hybrid mode; and
display means for reading out images stored in said memory means to then sequentially display said images at said monitor means during an operation of rewinding said silver salt film, said display means setting a display time per frame corresponding to the number of frames of a recorded electronic image.

2. The camera according to claim 1, wherein said display means determines said display time by dividing an expected value of the time required to rewind said silver salt film completely by the total number of frame of said electronic image.

3. The camera according to claim 1, wherein said display means inhibits display in said rewinding operation if all the frames of said silver salt film has been photographed in said silver salt mode.

4. A camera comprising:
electronic imaging means for recording a subject image by photoelectric conversion;
silver salt photographing means for recording a subject image on a silver salt film;
monitor means for displaying an electronic image picked up by said electronic imaging means;
mode switching means for switching between a hybrid mode in which said electronic imaging means picks up an image in synchronization with a silver salt photographing operation by said silver salt photographing means and a silver salt mode in which only a silver salt photographing operation by said silver salt photographing means is performed;
memory means for storing an electronic image picked up in said hybrid mode; and
display means for reading out image stored in said memory means and corresponded to a photography frame of a rewinding operation to then sequentially display said image at said monitor means when an operation of rewinding said silver salt film is started, said display means displaying a specific image if the image corresponded to the photography frame doesn't exist.

5. The camera according to claim 4, wherein said specific image contains a message indicating that there is no electronic image present.

6. The camera according to claim 4, wherein said specific image contains a message indicating that a photographing operation has been performed in said silver salt photography mode.

7. A camera comprising:
electronic imaging means for recording a subject image by photoelectric conversion;
silver salt photographing means for recording a subject image on a silver salt film;
monitor means for displaying an electronic image picked up by said electronic imaging means;
mode switching means for switching between a hybrid mode in which said electronic imaging means picks up an image in synchronization with a silver salt photographing operation by said silver salt photographing means and a silver salt mode in which only a silver salt photographing operation by said silver salt photographing means is performed;
memory means for storing a picked up electronic image in said hybrid mode and a specific image in said silver salt mode; and
display means for reading out images stored in said memory means to then sequentially display said images at said monitor means during an operation of rewinding said silver salt film.

8. A camera comprising:
electronic imaging means for recording a subject image by photoelectric conversion;
silver salt photographing means for recording a subject image on a silver salt film;
monitor means for displaying an electronic image picked up by said electronic imaging means;
mode switching means for switching among a hybrid mode in which said electronic imaging means picks up an image in synchronization with a silver salt photographing operation by said silver salt photographing means, a silver salt mode in which only a silver salt photographing operation by said silver salt photographing means is performed, and a digital mode in which only a photographing operation by said electronic imaging means is performed;
memory means for storing said electronic image; and
display means for reading out only images picked up in said hybrid mode of images stored in said memory means to then sequentially display said images picked up in said hybrid mode at said monitor means during an operation of rewinding said silver salt film.

9. The camera according to claim 8, wherein said memory means stores a specific image in said silver salt mode.

10. The camera according to claim 8, wherein said memory means stores also information corresponding to a photography mode along with said electronic image.

11. A camera comprising:
electronic imaging means for recording a subject image by photoelectric conversion;
silver salt photographing means for recording a subject image on a silver salt film;
monitor means for displaying an electronic image picked up by said electronic imaging means;
mode switching means for switching between a hybrid mode in which said electronic imaging means picks up an image in synchronization with a silver salt photographing operation by said silver salt photographing means and a digital mode in which only an imaging operation by said electronic imaging means is performed;
memory means for storing said electronic image; and
display means for reading out images stored in said memory means to then sequentially display said images at said monitor means during an operation of rewinding said silver salt film, said display means displaying said images excluding electronic images picked up in said digital mode.

12. A camera comprising:
an electronic imaging portion including an imaging element and an imaging optical system for forming a subject image on said imaging element;
a nonvolatile memory element for storing electronic image data output from said electronic imaging portion;
a display capable of displaying said electronic image data;
a signal processor circuit for controlling an imaging operation by said electronic imaging portion, an operation of storing by and reading out from said nonvolatile memory element, and a displaying operation by said display;
a silver salt film photographing portion including a silver salt photography optical system for forming said subject image on a silver salt film and an adjusting mechanism for adjusting an exposure for said silver salt film;
a rewinding mechanism for rewinding said silver salt film into a film cartridge;
a switch set for setting a hybrid photography mode in which an exposing operation by said silver salt film photographing portion and an imaging operation by said electronic imaging portion are performed almost simultaneously and a non-hybrid photography mode in which either one of an exposing operation by said silver salt film photographing portion and an imaging operation by said electronic imaging portion is performed;
a release switch; and
a CPU for controlling an operation by said signal processor circuit and an exposing operation by said silver salt film photographing portion according to said photography modes when said release switch is operated,
wherein said signal processor circuit reads out electronic images picked up in said hybrid mode from said memory means to thereby display said electronic images sequentially at said display when a rewinding operation is being performed by said rewinding mechanism.
